(19) United States
(12) Patent Application Publication
(10) Pub. No.: US 2023/0298114 A1
(43) Pub. Date: Sep. 21, 2023

(54) Blockchain Based System for Storing Data Regarding Ownership and Value of Real Estate Shares

(71) Applicant: Groma, LLC, Boston, MA (US)

(72) Inventors: Seth M. Priebatsch, Boston, MA (US); Christopher M. Lehman, Boston, MA (US)

(21) Appl. No.: 17/699,847

(22) Filed: Mar. 21, 2022

(51) Int. Cl. G06Q 50/16

(52) U.S. Cl. CPC G06Q 50/16

(57) ABSTRACT

Computer system and method create a verifiable record of asset ownership and asset valuation. A blockchain stores and maintains data including i) a record of a subject asset comprised of disparate sub-assets and ii) values of the subject asset and the sub-assets. A first immutable ledger of the blockchain responsively executes purchase of a fraction of the subject asset and automatically records ownership of the fraction of the subject asset for the purchasing user. A second immutable ledger provides view access to third parties for verifying the record of ownership by the purchasing user.

### BACKGROUND

Purchasing a home is a major life milestone for many people, and most people choose to acquire homes via a mixture of directly invested equity dollars and borrowed dollars via a mortgage. One of the most important components in that mortgage is getting a valuation of the underlying asset (in this case the house) so that a certain portion (say 80%) of that value can be loaned to the borrower and secured by the full value of the house. Without an asset valuation, a mortgage cannot be qualified for as the lender is unable to prove that the mortgage is backed by sufficient equity. This asset valuation is a specialized task done by property assessors and comprises generally an on-site visit and written report, which is then vetted / evaluated by the borrower and lender. However, this process is predicated on the assumption that the asset being purchased and backing the mortgage is a single complete real estate unit such as a house or a condo. Because of the prices associated with such complete real estate units, many potential home buyers are unable to qualify for a mortgage and purchase a real estate unit. A need exists to lower the barrier of entry and the capital required for property ownership.

### SUMMARY

Many individuals, especially those with lower incomes, are unable to save up enough money for a down payment on a mortgage, and as a result end up stuck in a cycle of paying hundreds or thousands of dollars in rent each month without building any financial equity. Applicants address the need to lower the barrier of entry and the capital required for real property ownership. The principles of Applicant’s invention disclosed herein securely adapt the loan and asset valuation process to the purchase and ownership of fractional real estate assets. Restated, the inventions and innovations disclosed herein provide options for individuals unable or unwilling to purchase a complete real estate unit to achieve and enjoy the benefits of real estate ownership. Embodiments of the present invention provide a method, and corresponding system, that (i) enable individuals to acquire fractional ownership of a real estate asset, such as a private REIT or fractional ownership across a disparate set of assets grouped together by some geographic, financial, or other similarity, and (ii) enable the creation of a verifiable secure record of fractional ownership of the real estate asset or assets. As used herein, the term REIT shall also include fractional ownership across a disparate set of grouped assets, even if not structured specifically as a REIT. The verifiable secure record permits accurate and up to date valuation of the fractional asset and the underlying valuations of other grouped real estate assets. At least due to the verifiable secure ownership record and accurate valuation, the fractional asset can be used as collateral for a loan in a similar manner to a house in a traditional mortgage. Embodiments provide solutions to a problem many individuals have, namely, how to build real estate wealth incrementally and leverage that wealth when they are short of being able to purchase a complete real estate asset.

A computer-implemented method of creating a verifiable record of asset ownership and asset valuation that comprises storing data including i) a record of a subject asset comprised of disparate sub-assets and ii) values of the asset and the sub-assets. The method includes automatically determining current values of the sub-assets based on intrinsic characteristics of the sub-assets and market conditions and updating the stored data based on the determined current values of the disparate sub-assets. Next, the method receives, from a user through an interface, an input comprising a request to purchase a part of the asset at a price and determines, based on the stored data and the received request, a fraction of the asset equivalent to the price included in the input. Then the method incudes executing a computer readable code stored on a first immutable ledger configured to automatically transfer ownership of the fraction of the subject asset to the user and to record on a secondary immutable ledger, a record of ownership by the user of the fraction of the subject asset. The method concludes by providing view access to the second immutable ledger, the view access enabling a third party to verify the record of ownership by the user of the fraction of the subject asset based on the second immutable ledger.

In some embodiments, the sub-assets are real estate assets. Additionally, the computer readable code may be a smart contract configured to allow the user to purchase the fraction of the subject asset when executed.

The first and the second immutable ledgers may be blocks in a blockchain. In some such embodiments, the blockchain is an Ethereum blockchain. The record of ownership by the user of the fraction of the subject asset may comprise a unit of a cryptocurrency.

Automatically determining the current values of the sub-assets may employ an algorithm configured to utilize at least one of rental data, tax data, capitalization rates when determining the current values of the disparate sub-assets. The employed algorithm may determine current values of the sub-assets in real time. Furthermore, the automatically determining of the current values of the sub-assets can be performed at a predefined frequency.

The data including i) a record of a subject asset comprised of disparate sub-assets and ii) values of the asset and the sub-assets may be stored on blocks in a blockchain.

A computer-based system providing a verifiable record of asset ownership and asset valuation that comprises a memory configured to store data including i) a record of a subject asset comprised of disparate sub-assets and ii) values of the asset and the sub-assets and an interface configured to receive, from a user, an input comprising a request to purchase a part of the asset at a price. The system also includes a processor configured to automatically determine current values of the sub-assets based on intrinsic characteristics of the sub-assets and market conditions, update the stored data based on the determined current values of the disparate sub-assets, and determine, based on the stored data and the received request, a fraction of the asset equivalent to the price included in the input. The system further includes a first ledger that stores a computer readable code that, when executed, is configured to automatically transfer ownership of the fraction of the subject asset to the user and to record on a secondary immutable ledger, a record of ownership by the user of the fraction of the subject asset, wherein the second ledger enables a third party to verify the record of ownership by the user of the fraction of the subject asset based on view access to the second immutable ledger.

The processer may be further configured to utilizes an algorithm configured to utilize at least one of rental data, tax data, capitalization rates when determining the current values of the disparate sub-assets to automatically determine the current values of the sub-assets employs. In such embodiments, the processer may be configured to utilizes the algorithm to determine current values of the sub-assets in real time. The processer may also be configured to automatically determining of the current values of the sub-assets is performed at a predefined frequency.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a schematic illustration of a blockchain utilized by embodiments of the invention.

FIG. 1B is a block diagram of an example embodiment of a system for creating and managing transactions on the blockchain of FIG. 1A.

FIG. 2 is a flow chart of method for creating a verifiable record of fractional ownership in an embodiment of the invention.

FIG. 3 is a flow chart of a method for valuating properties within the property base utilized by embodiments of the current invention.

FIG. 4 is a flow chart of a method of securing a loan based on fractional ownership of a group of real estate assets in embodiments or in systems utilizing embodiments of the present invention.

FIG. 5 illustrates a computer network or similar digital processing environment in which the present embodiments may be implemented.

FIG. 6 is a diagram of the internal structure of a computer (e.g., client processor/device or server computers) in the computer system of FIG. 5.

### DETAILED DESCRIPTION

A description of example embodiments follows.

Embodiments of the disclosed invention enables users to bypass the barriers to entry that have traditionally kept attractive real estate investment opportunities off-limits to all but the most established investors and institutions. In part because of its use of technologies such as blockchain, an embodiment of the invention is able to provide the benefits of real estate investing and ownership to everyday investors. In traditional mortgages, home equity is the foundation and supporting collateral used to justify the risk of granting the loan. Without sufficient collateral, no loan can be given. On the home buyers side, the opportunity for the growth in value of the home’s (subject real estate asset’s) equity justifies the loan and interested paid. Additionally, the equity of the home can be used to support future loans often larger than the initial mortgage due to the growth in its value over time. This incremental use of home equity and its growth to support increasingly expensive real estate purchases and/or investments is referred to as the real estate ladder and is an essential way to build wealth. However, many aspiring home owners/investors can never reach the first rung of the ladder as the upfront cost of obtaining the initial real estate asset can be prohibitive.

The present invention enables an alternative to the traditional mortgage backed by a single discrete asset. In contrast, embodiments of the present invention allow for a loan to be supported by collateral comprising of ownership of fractions of many assets (e.g. shares in a REIT or fractional ownership of any number of individual assets in a group). Since fractional asset ownership does not require the purchase of a complete asset, it can be purchased with any amount of starting capital. Additionally, since the fractional assets are still real estate assets, they are less volatile, prone to appreciation, and trusted by lenders therefore, they can be used as collateral for lower interest and higher leveraged loans, similar to traditional mortgages. Such loans can also be used to build equity if (when) the value of the fractional real estate assets and provided dividends increase faster than the accrued interest. In other words, embodiments enable a way for home owners and/or investors to begin their journey up the property ladder regardless of the magnitude of initial investment. Giving all individuals the ability to build a substantial amount of wealth without needing to earn more money or reduce their consumption elsewhere has the potential to provide long-term financial security for huge swathes of the population that have historically struggled to achieve this.

However, such an approach creates new technical problems that must be addressed. The first issue is that of valuation, without up to date knowledge of the value of the asset to be used as collateral a loan cannot be secured. A single complete asset is straightforward to valuate and can often be partially done during an in-person inspection by an assessor. In contrast, if an individual owns portions of many different real property assets, potentially thousands, a direct in person valuation is impractical if not impossible. The second issue is that of verifiability. Ownership of a single real property asset is officially recorded, for example at the registry of deeds. A loan provider knows they can trust these recordings to verify that a loan requester actually owns the equity to be used as collateral. Providing proof of fractional ownership of many different real estate assets is a more complex task. To solve both of these issues, embodiments of the present invention include methods, and corresponding systems, that are able to evaluate a portion of many different real estate assets and create a verifiable record of ownership of that portion of different assets. This enables an individual to obtain, at a far lower price, real estate assets and leverage those assets as collateral for a loan.

Embodiments of the invention include a blockchain based system that stores data regarding the ownership and value of portions or fractions of a real estate asset. The real estate asset may be comprised of disparate individual assets and be structured as a real estate investment trust (REIT) or an alternative manner of asset grouping that offers shares that provide to ownership of a portion of the total real estate assets. Embodiments store data about the overall value of the real estate assets and the value of its component properties and/or assets. Embodiments of the invention, on a recurring basis, use both the intrinsic characteristics of the component assets and current market conditions to determine the value of the component assets and also the value of the total real estate asset or REIT. Embodiments update the stored data to reflect any change in valuation. This process ensures that the valuation of both the total real estate asset and any portion or fraction thereof is accurate and up to date, setting the foundation for use as loan collateral.

An individual can purchase a portion, or shares, of the real estate asset for a proposed price. Embodiments of the invention calculate, using the stored valuation data, the fraction of the real estate asset, or number of shares of the REIT or grouped asssets, the individual should receive ownership of in exchange for the purchase price. Next the embodiment creates a record of ownership of the purchased portion of the real estate asset and a record that the purchased portion has been transferred to the purchasing individual. Importantly, embodiments store this record of ownership on a blockchain. In some embodiments, ownership in a portion of the real estate asset is denoted by a record of ownership of a coin or token of a cryptocurrency built on the blockchain. By storing the record of ownership of a portion of the real estate asset on the blockchain, the embodiment creates verifiable and immutable proof that an individual owns a specific asset that has a specific value backed by tangible real estate. This solves the two problems discussed previously, valuation and verification, and allows for the purchased portion of the real estate asset to serve as loan collateral.

A loan that utilizes fractional real estate asset ownership as collateral and enabled by embodiments of the present invention has several advantages over a traditional mortgage secured by a single property. First, the loan is disassociated from the underlying real estate where the loan holder lives. This enables individuals to begin building real estate equity without the need to commit to a specific and illiquid often pricy home asset. Second, the requirement of an initial down payment is removed. This benefit also stems from the fact that a complete asset does not need to be purchased allowing for smaller and more diverse investments. Third, it permits low interest rate loans to be supported by low value assets. Traditionally, only high value assets, such as a complete real estate asset or large stock portfolios, would be used as collateral for low interest loans. However, because embodiments of the present invention enable loans to be secured by fractional ownership of a distributed real estate assets, the loan underwriter still gets the same risk profile as a traditional mortgage, or potentially a better more diversified risk profile, justifying low interest rates, but the loan receiver does not need to purchase an asset as expensive as a complete real estate asset. Finally, the loan can be offered at an initial loan rate of 100%, allowing individuals to fully leverage the equity of their fractional asset ownership. This is possible in part because the fractional real estate assets are far less volatile than other assets such as stocks and in contrast to regular personal home mortgages, the fractional real estate assets can produce dividends to partially offset, or even exceed, the interest payments, a possibility that is improved because of the diversified nature of the owned fractional asset. Additionally, the loan receiver and loan provider can both benefit from the expertise of a third party, such as a REIT management company, that directs and controls the complete real estate asset. In fact, if the real estate asset appreciates, the loan will no longer be 100% leveraged.

Embodiments of the invention also provide benefits to lenders by enabling the incorporation of recovery mechanisms for the fractional ownership in assets securing the loan. These recovery mechanisms may be smart-contracts stored on and executed by blocks on a blockchain that enable automatic collateral recovery in the case of loan default. This provides alternatives to the highly arduous and time consuming process of recovering a mortgaged property through, for example, a foreclosure process. Furthermore, by improving the ability of lenders to recover collateral, embodiments of the invention increase loan availability by decreasing the risk lenders take when they loan to higher risk borrowers.

Principles of the present invention also leverage technology to improve efficiency. The purchase of the fractional real estate asset and the underwriting of a loan using it as collateral can be executed via a smart contract stored and executed on the blockchain (record of ownership). Other aspects of the loan and asset ownership may also be executed via smart contracts such as, but not limited to, interest assessment and collection, dividend payment, and the consequences of delinquent or missing payments. Blockchains are a distributed ledger technology that allows for mutual verification, approval and sharing of transaction records among nodes distributed at multiple hubs on a computer network. Blockchains allow for: (a) decentralized transactions not relying on a third party’s trust (direct transactions between participants are possible), (b) the creation of resilient networks due to mutual data/system management, and (c) the prevention of tampering of recorded data (only new entries can be added by design, control over the recording of new data or records as new entries requires consensus among transaction parties, and fraudulent entries are rejected by parties). Smart contracts are transaction conditions programmed and incorporated into blockchains that, when the predetermined contract conditions are met, the transaction is automatically performed.

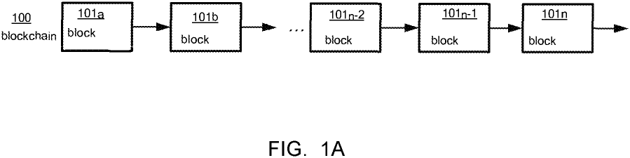

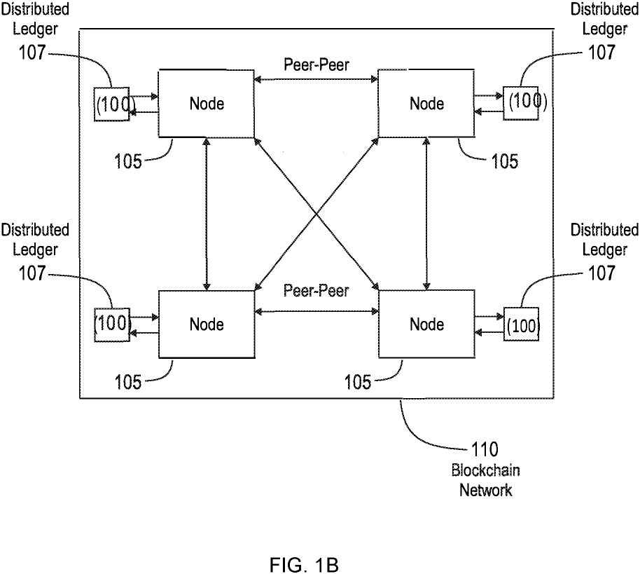

FIG. 1A is a schematic illustration of a blockchain 100 utilized by embodiments of the invention. In particular, methods and systems embodying the present invention utilize blocks 101 of a blockchain 100 to store data, for example ownership records and asset value. Embodiments of the invention may also allow that stored data to be viewed and verified by third parties, such as a loan distributor. A blockchain 100 is a public, secure, distributed, cryptographically-proven ordered list. Illustrated blockchain 100 is comprised of multiple blocks 101a-101n (generally referenced 101 throughout this disclosure). The first block 101a is known as the genesis block. After the genesis block 101a, each block refers back to the previous block (its predecessor block 101) in the chain. This is illustrated with arrows between the blocks 101. For example, block 101b refers back to block 101a and so on. Referring back can be done in a variety of ways, e.g., by including some part of the previous block, e.g., an identifier or its consensus proof, or a value computed over the previous block, e.g., a hash, a signature, etc. A blockchain is often used for a specific type of ordered list, an ordered list of transactions, monies paid and owed, called a ledger. In such a use case, each block 101 may include a record of a transaction. A block 100 may include records of one or more transactions. Some embodiments, may allow blocks 101 with zero transactions, e.g., to support timely delivery of new blocks. The transactions may be transactions utilizing a cryptocurrency, for example a cryptocurrency backed by shares in a REIT, but this is not required. When used as a ledger, a blockchain 100 can provide verification for a sequence of transactions.

Blockchain 100 is also provable. Using cryptography, it can be ensured that each block 101 is complete before the next block (its successor block 101) is initiated. For example, if the blockchain 100 is an ordered ledger with blocks 101 representing individual transactions, then the blockchain verifies that the transaction recorded by block 101b is completed before verifying that the transaction recorded by block 101c is completed. This is extremely useful in creating records for transactions that have cause and effects, e.g., a first user purchases a real estate asset, recorded in block 101b, and then the first or a second user pays for that real estate asset, recorded in block 101c. To accomplish this, blockchains 100 use cryptography to create proof that a block 101 is complete and is followed by its subsequent block. Typically, each of the blocks 101 comprises a consensus proof, computed over one or more transactions. The consensus proof is a cryptographic signature that establishes each block’s completeness and location in the blockchain 100. In some embodiments of the invention, the consensus proof is created by using a cryptographic kernel that generates a public/private key pair. Various equivalent Cryptographically Secured Distributed Ledger technologies may be used such as: Blockchain, Hashgraph, Directed Acyclic Graph, etc., as such technologies support the same concepts: consensus algorithms, cryptocurrencies, tokens, etc.

Another key feature of blockchains 100 is that they are distributed. Blocks 101 may be stored on difference devices in different locations. However, these blocks are still connected in the blockchain 100 due to their cryptographic signature. Additionally, blocks 101 may be accessed and viewed from difference devices in different locations. This enables third parties not part of a transaction recorded on the blockchain to view and verify that the transaction has occurred. Additionally, because of the security provided by the block’s cryptographic signatures, the blockchain 100 and its component blocks 101 cannot be distrusted or altered. This enables the blockchain 100 and individual blocks 101 to be reliable and trustable records despite their distributed nature. Another level of security is added due to the public nature of blockchain 100 and its blocks 101. Since the blockchain is public, may copies of it and/or its component blocks can be created. These copies would naturally also have the cryptographic signatures in the blocks 101. Therefore, even if one copy of the blockchain 100 or blocks 101 was manipulated by a bad faith actor, the other copies could be used as a verification tool to exclude incorrect data as manipulating all public copies would be difficult if not impossible.

Blockchains provide the ability to track and settle balances and transactions for networks with thousands or even millions of geographically dispersed people who might not know, let alone trust, each other. Blockchains enables trustless transactions without the need for a centralized authority. Embodiments of the invention utilize blockchains as part of a novel and unique approach to create verifiable records of the purchase and ownership of fractions of many different dispersed real estate assets. Data memorializing the purchase and/or ownership of fractions of a real estate asset can be stored on one or multiple blockchain 100 blocks 101. The payment for and transfer of these ownership fractions can also be stored on one or multiple blockchain 100 blocks 101. In addition, the blocks 101 may be ordered to require the payment be completed before the ownership is transferred. Finally, because of the transparency, security and verifiability of the data stored in blocks 101 in the blockchain 100, it can be used by lenders to ensure that the loan requestor actually owns the fractional real estate asset to be used as collateral. This avoids the inefficient processes of relying on official government records as is done for mortgage underwriting and may even be impossible for dispersed fractional asset ownership. The blockchain 100 and its component blocks 101 can serve as a proof of ownership that a lender and underwriter can rely on, due to the blockchain’s security features, to verify asset ownership.

FIG. 1B is a block diagram of an example embodiment of a system for creating and managing transactions on a blockchain 100 utilized by embodiments 1000 (in FIG. X) of the invention. The system comprises a blockchain network 110 with a plurality of nodes 105. The nodes 105 may be in peer to peer communication with each other and implemented by computer nodes (clients, servers, devices, etc.) 50, 60 in a computer-based network described later in FIG [X]. Each node 105 in the blockchain network 110 may contain a distributed ledger 107 that includes a copy of the blockchain 100. Transactions, that are recorded on the blockchain 100 are recorded in the distributed ledgers 107. Nodes 105 may view and verify the distributed ledgers 107 located on other nodes 105.

In some embodiments of the invention, the blockchain 100 utilized is the Ethereum blockchain. Ethereum is a vibrant, battle-tested ecosystem that facilitates trustless transactions. In such embodiments, the individual blocks 101 may record ownership of a cryptocurrency token built on the Ethereum blockchain 100. However, a person skilled in the art should understand that embodiments of the invention could be implemented on a wide variety of currently existing blockchains and be adapted for blockchains developed in the future.

While some embodiments may choose to directly record fractional ownership of assets, other embodiments may utilize a cryptocurrency built on the blockchain that is backed by real estate. In such embodiments, a base comprising a collection of properties, or portions of properties, is created. This base may be structured as a REIT with a management company directing investment and property acquisition. Data regarding transaction, value, and ownership of the properties in the base, may be stored in blocks 101 of the blockchain 100 or alternatively in a traditional centralized database. Unlike cryptocurrencies such as bitcoin which is not supported by or connected to any tangible asset, the properties in the base can be used to support the value of a real-estate backed cryptocurrency. In other words, units or tokens of this real-estate backed cryptocurrency correspond to ownership of a portion of the properties in the base. If the base is structured as a REIT, units or tokens of this real-estate backed cryptocurrency correspond to ownership of shares in the REIT. Furthermore, when a user purchases real-estate backed cryptocurrency from the property base managers, the compensation received can be invested back into the property base increasing the value of the base and subsequently the purchased cryptocurrency.

Transactions regarding and ownership of tokens of the real-estate backed cryptocurrency are recorded and verified on blocks 101 of the blockchain 100 creating a verifiable secure record. This verifiable secure record can enable the cryptocurrency tokens to be used as collateral for a loan. Since the cryptocurrency is backed by the value of the collection of real estate assets in the base, the cryptocurrency will (i) be able to provide lenders similar confidence, security and value as direct property ownership, and (ii) enable their owners to secure favorable loan terms similar to a traditional mortgage. However, unlike a traditional mortgage, the barrier of entry to purchase the collateral is far smaller, a token representing fractional ownership versus a complete real estate asset. In addition, because token transactions and ownership are recorded and verified on blocks 101 of blockchain 100, a lender can be confident that the anyone offering the tokens as collateral is the true owner of the token and therefore the corresponding portion of the base properties. This can be done without the need to examine the official records of the potentially thousands of properties comprising the property base and/or the purchase of portions of that base by individual token holders. Finally, if the value of the base is made public, either due to records stored on the blockchain 100 or in a more traditional manner, the lender will also be able to verify the value of the cryptocurrency tokens being offered as collateral.

An example embodiment of the invention utilizes the Ethereum blockchain to create both verifiable records of the properties in the base and of the cryptocurrency tokens representing fractional ownership in the base. A building generator is used to create ERC-721 non-fungible (i.e. unique) tokens (“NFTs”) that represent each distinct property in the base. The created tokens may include information about the distinct property including ownership, value, and/or intrinsic properties such as location, square footage, layout, condition, etc. that can be used to determine value and be stored in blocks of the Ethereum blockchain. The ERC-721 tokens create a verifiable record of the component properties of the base on the Ethereum blockchain. This verifiable record may also contain the information required to evaluate the component properties and the entire base. The creation of new tokens may be restricted to use of a private key that is only used to instantiate new properties to the base.

The example embodiment can also use a cryptocurrency token generator that defines how the tokens behave and where each token is stored. The tokens may be ERC-20 tokens, an Ethereum standard for fungible (i.e. identical to each other of its kind) tokens. The cryptocurrency token represents ownership of a portion of the base and therefore potions of the real estate assets that make up the base. Information regarding the ownership and transactions of the created cryptocurrency tokens may be stored in blocks of the Ethereum blockchain. These cryptocurrency tokens may also be designed to comply with the Ethereum standard ERC-1404 to meet security regulations. The creation of new cryptocurrency tokens may be restricted to only occur when new real estate assets are added to the base to ensure a one to one between the value of the assets, represented by ERC-721 tokens, and the value of the cryptocurrency, represented by ERC-20-compatible tokens. The cryptocurrency tokens, after their creation and initial distribution, will also be able to be bought and sold on the open market and records those transactions also stored and verified by blocks on the blockchain.

In combination, the cryptocurrency tokens and NFTs create a transparent and secure verifiable record of ownership of a fraction of the set of properties comprising the base by the holder of the cryptocurrency. The properties’ value, and therefore the cryptocurrency’s value, can be stored and verified by data on the Ethereum blockchain. Finally, by providing access to the stored data on the Ethereum blockchain, a third party, such as a loan provider, can efficiently and securely verify the equity represented by a cryptocurrency token and justify using that token as loan collateral. While the aforementioned example utilizes the Ethereum blockchain and its protocols, a person of skill in the art would understand that embodiments may also be executed on other blockchains using equivalent protocols.

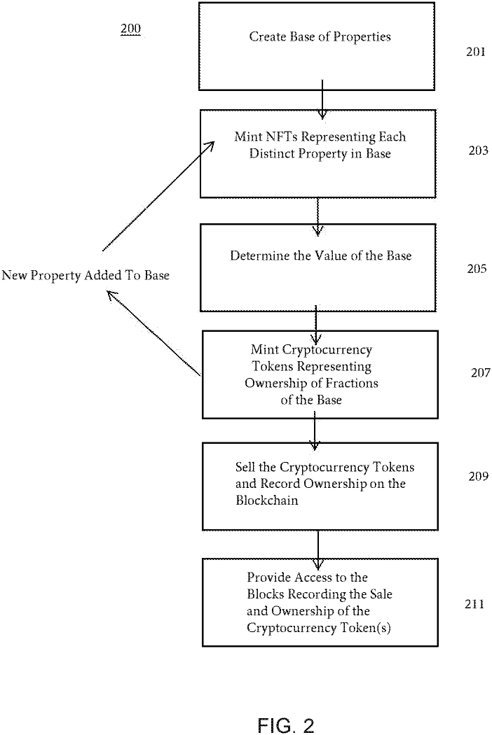

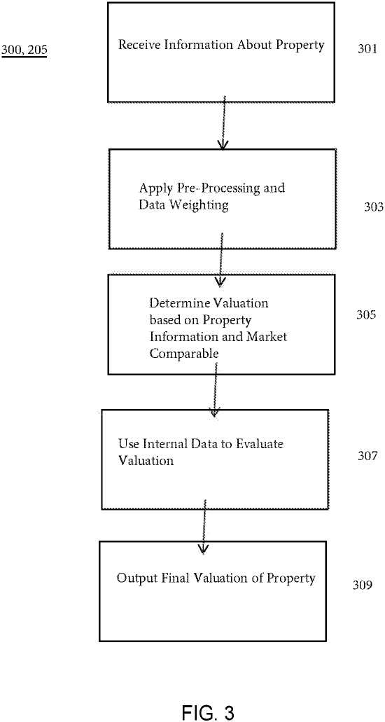

FIG. 2 is a flow chart of a method 200 for creating a verifiable record of fractional ownership in an embodiment 1000 of the invention. First, in step 201, a base is created. The base comprises ownership of multiple distinct real estate assets. The creation, management, and overseeing of the base may be performed by a management company with expertise in real estate investment. The base may be structured as REIT. After the base is created, in step 203, for each distinct property in the base, an NFT is created and stored in blocks 101 on the blockchain 100. The NFT includes a record sufficient to identify each distinct property. The NFT may also include records of either the valuation of its represented distinct property and/or intrinsic property information that can be used to calculate the value of the represented distinct property. The NFTs may be publicly viewable so that third parties may verify the recorded information and a property’s inclusion in the base. Then the value of the total base is determined 205 based upon the value of its component distinct properties. This may be done automatically using the method of FIG. 3 or similar algorithm that calculates the respective values of the distinct properties based on their intrinsic properties (characteristics) and/or market conditions. Other suitable h algorithms are known or common in the art.

After the base is created 201 and valued 205, cryptocurrency tokens can be minted 207 that represent ownership of a fraction of the base. If the base is a REIT, the cryptocurrency tokens minted at 207 can represent shares in the REIT. Each minted cryptocurrency token is backed by an initial amount of real estate. This may be done at a 1:1 ratio, for example if the base contains $1,000,000 worth of real estate across its component assets, one million cryptocurrency tokens can be minted so that at the time of minting, one cryptocurrency token is equal to 1 USD. Additionally, at minting, each token represents the same amount of percentage ownership in the base. For example, if 100 tokens are minted, each token represents a 1% ownership of the properties in the base. As the base adds property(ies) and appreciates, the value of the cryptocurrency tokens will increase even if it represents a smaller share of the total base. Steps 203 through 207 may be repeated as new properties are added to the base. New cryptocurrency tokens may only be minted when new assets are added to the base. However, it is important to note that since the cryptocurrency tokens are fungible, they are not intrinsically tied to a specific property in the base but instead always represent a fractional ownership of the entire base. Each cryptocurrency token resulting from step 207 is a truly diversified fractional piece of the large amount of component real estate assets that comprise the base.

In step 209, the minted cryptocurrency token(s) (output from 207) are sold to a purchaser. The transaction and new ownership of the token(s) are recorded on the blockchain 100. The number of tokens purchased is determined by the purchase price and the value of the portion of the base represented by each cryptocurrency token. If the NFTs minted in step 203 include property value, or information sufficient to determine property value, this number of tokens purchased can be determined by viewing the blockchain 100 on which the NFTs are recorded. The sale 209 of the cryptocurrency tokens creates a verifiable record in the blocks of the blockchain 100 on which the cryptocurrency was built of fractional ownership of the properties in the base. Finally, in step 211, a third party can be provided access to the blockchain blocks 101 that record the sale and ownership of the cryptocurrency token(s). Because of the transparent and secure nature of blockchain data storage, the third party can verify that an individual is the true owner of the token and that the token is backed by the actual real estate assets that comprise the base. In addition, and importantly, with access to the blockchain blocks 101, the third party can verify the representative value of the token owned by the individual. This permits the use of the cryptocurrency tokens as loan collateral. The blockchain blocks 101 may be stored on any amount of the distributed ledgers 107 of the nodes 105 in the blockchain network 110. Furthermore, the copies of blockchain blocks 101 in distributed ledgers 107 of the nodes 105 can be used to verify the accuracy of the stored record of sale and ownership of the cryptocurrency token(s). In additional, a third party can be provided access to the blockchain blocks 101 that store the NFTs minted in step 203 to verify that the cryptocurrency tokens are back by actual real estate assets.

In some embodiments, including those that utilize the Ethereum blockchain 100, a variety of smart contracts can be utilized to fulfill Know Your Customer (KYC), Anti Money Laundering (AML), and Office of Foreign Assets Control (OFAC) functions, including a verified account adder and a recovery mechanism. Smart contracts can also be used to automate transactions and store records of them on the blockchain blocks 101 in distributed ledgers 107, including the purchase of fractional ownership of the grouped assets, the transfer of fractional ownership of the group assets, the purchase and sale of NFTs or cryptocurrency that represents fractional ownership of the grouped assets, loan distribution, interest calculation and collection, dividend calculation and distribution, and loan default and collateral recovery. These smart contracts can be stored on and executed using the Ethereum, or equivalent, blockchain and architecture. The smart contracts can also be automatically executed increasing reliability and trust in the preformed transactions, despite the distributed nature of the blockchain.

Embodiments of the invention may utilize a valuation algorithm that can determine the value of the properties in the base using their intrinsic values and the market conditions. This algorithm can be run on a recurring basis (predefined or preset frequency) so that the asset valuation remains current to build and maintain confidence in the equity value of fractional ownership of the base. The algorithm may provide a real-time valuation of the properties, individually within the base, the total base, and for the corresponding cryptocurrency token. In some embodiments, outside source information may be employed such as Zillow Estimates and tax assessments may be utilized as inputs for the algorithm. The valuation algorithm may utilize as primary inputs current and projected rental income, outstanding debt and associated interest payments, applicable taxes, and expected administrative/maintenance costs. The algorithm may also utilize valuation information for properties in the base, or group of assets, as additional inputs for and/or validation metrics for the calculated valuation of other properties in the base, or group of assets. This self-referencing ability, enables the algorithm to become increasingly accurate as the base grows and more properties are valued.

FIG. 3 is a flow chart of a method 300 for valuating properties within the property base utilized by embodiments, such as at step 205 of FIG. 2, of the current invention. Method 300 may be implemented as an algorithm (or processor routine) which when executed by a digital processor provides real-time valuation of the properties within the base. First, information about the property is received 301. This information may be physical characteristics of the property, e.g. square footage, number of bedrooms/bathrooms, and non-physical characteristics such as but not limited to purchase price, rental income, location, age. Next, the received information may be pre-processed in step 303 for example to identify missing, or bad data that can be corrected or excluded. Also in step 303, the method 300 may apply weights to the received information to increase or decrease the relevance of certain received information 301. In step 305, an initial valuation is determined based on a comparison between the received property information 301 and comparable market information. For non-limiting example, the method 300 may compare a property in a location with two bedrooms and one bathroom and 1000 square feet to the sale price, rental price, and valuation of other properties in that location, also with two bedrooms and one bathroom and approximately 1000 square feet. Based on this comparison, a valuation of the property can be calculated. Next, some embodiments apply step 307 where the calculated valuation of step 305 is compared to internal data, such as the valuation of other properties in the group of assets. This comparison may be used to adjust the determined valuation based on market comparable. Finally, in step 309, the final valuation of the property is outputted. This may be displayed to a user through a user interface and/or be record on a block of a blockchain. Based on the final valuations, determined with method 300, of the properties in a group of assets, the total value of the group, and any fractional ownership thereof, can be calculated, recorded, outputted, and/or displayed.

One application of the invention disclosed herein is to enable loans using the cryptocurrency tokens, backed by fractional ownership of a collection of real estate assets, as an alternative to the traditional mortgage. In other words, instead of buying a complete real estate asset with a mortgage using that asset as loan collateral, an individual can purchase cryptocurrency tokens and use the purchased cryptocurrency tokens as loan collateral. Since the cryptocurrency tokens are backed by actual real estate assets in the base, they experience application the same way a regular real estate asset would. As the assets in the base appreciate and issue dividends, if that exceeds the interest on the loan, an owner of the cryptocurrency tokens builds equity even if they used those tokens, leveraged at 100%, as equity for a loan.

Embodiments of the invention may employ a user interface for purchasing tokens/shares (or other representations of fraction ownership) that may utilize a web3 interface connecting the user display to blockchain smart contracts. This user interface can display the current conversion rates between the tokens or share equivalents implemented as smart contracts on the blockchain, using the automatically assessed valuation of the underlying real assets, and the fiat/digital currencies that can be used to purchase them. A user uses the user interface to enter the desired quantity of tokens/shares to purchase and the currency being used to purchase them. In turn, the interface calculates the total price in the selected currency. Once the transaction has been submitted through the user interface, the user is redirected to a display that shows their existing balance of tokens/shares and any other currencies in their account, including the total value of all assets with the ability to select different units in which to express this total.

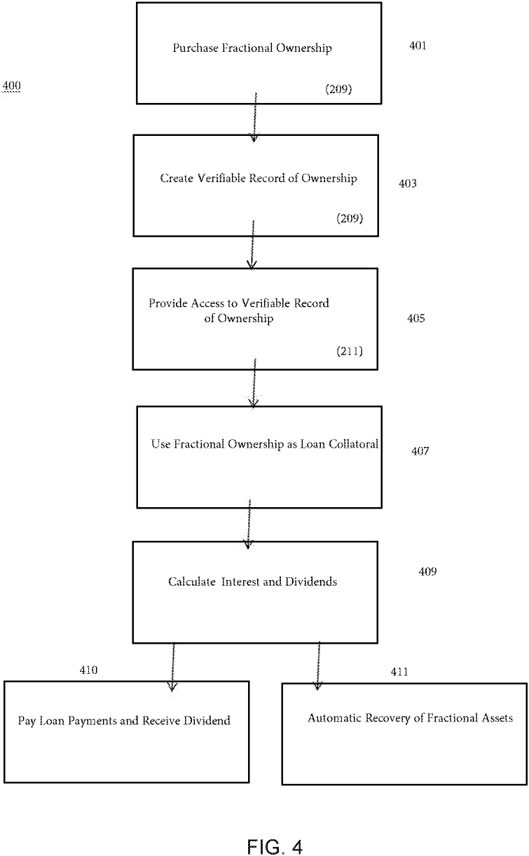

FIG. 4 is a flow chart of a method and system 400 employed in embodiments enabling or supporting a user to secure a loan based on fractional ownership of a group of real estate assets. First, a user purchases 401 fractional ownership in a group of real estate assets, for non-limiting example a REIT. This purchase may be done using a web3 interface and/or executed with a smart contract on the blockchain 100 such as at step 209 of FIG. 2. Next, the system and method 400 automatically creates 403 a verifiable record of ownership of the fractional real estate asset. This verifiable record may be stored on blockchain 100 in the distributed ledger 107 of nodes 105 such as at step 209 in FIG. 2. The verifiable record may be in the form of a cryptocurrency token, NFT, or shares. After, the verifiable record is created, a user may provide access 405 to a lender to that created record such as at step 211 in FIG. 2. Because the verifiable record can be stored on a blockchain 100 and supported by the value of the grouped real estate asset, a potential lender can trust that the user can support a requested loan. After the lender accesses the verifiable record of ownership, the fractional ownership that record denotes is used as collateral 407 for a loan from the lender to the user. This loan, and its terms, may also be executed by smart contract and/or stored on blockchain 100. At this stage, the user has a loan underwritten by real estate assets, similar to that of a traditional mortgage but with greater diversification of risk and lower barrier to entry. In some embodiments of the invention, method 400 terminates at step 407.

After the loan is distributed, other embodiments of the invention utilize the novel and unique properties of the invention to further improve the loan process. For example, loan interest and dividends in the fractional ownership may be automatically calculated 409 and applied to the user. The user may then pay the set loan payments and receive their dividends 410. The user may choose to use the dividends to pay off the interest and principle of the loans increasing the user’s equity. These calculations and payments may be done automatically using smart contracts and/or recorded on blockchain 100. The ability to automatically create a distributed, verifiable, and accessible record of all steps of the loan process increases trust between the parties and decreases risk. If the user does not pay their loan and defaults, the lender may initiate automatic recovery 411 of the loan collateral and take ownership of the fractional assets. This recovery may be executed by a smart contract and/or automatically recorded on blockchain 100.

### Digital Processing Environment

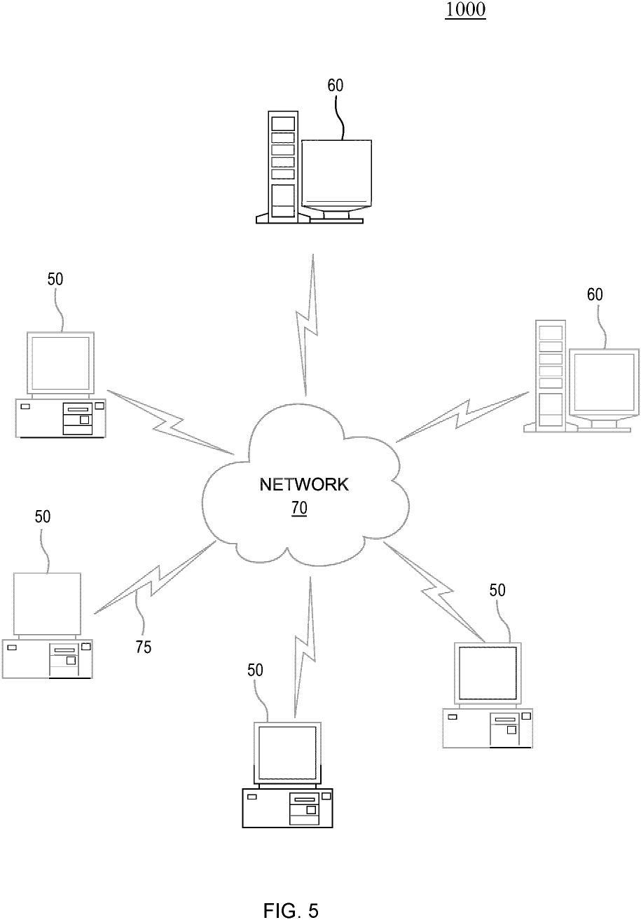

FIG. 5 illustrates a computer network or similar digital processing environment in which the present embodiments 1000 may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

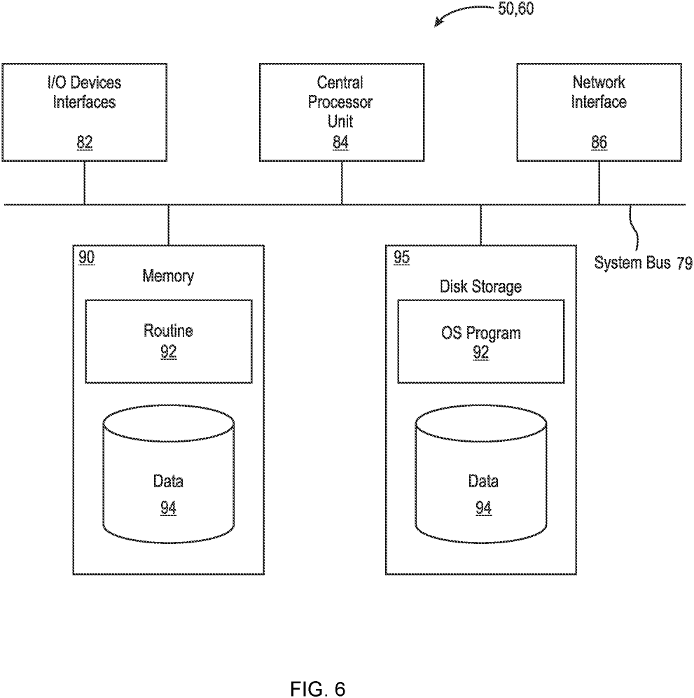

FIG. 6 is a diagram of the internal structure of a computer (e.g., client processor/device 50 or server computers 60) in the computer system of FIG. 5. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, and network ports) that enables the transfer of information between the elements. Attached to system bus 79 is I/O device interface 82 for connecting various input and output devices (e.g., keyboard, mouse, displays, printers, and speakers) to the computer 50, 60. Network interface 86 allows the computer to connect to various other devices attached to a network (e.g., network 70 of FIG. X). Memory 90 provides volatile storage for computer software instructions 92 and data 94 used to implement embodiments (e.g., blocks 101 of a blockchain, blockchain network nodes 105, distributed ledgers 107, method 200, smart contracts, valuation algorithm(s), and user interface(s) described above). Disk storage 95 provides nonvolatile storage for computer software instructions 92 and data 94 used to implement many embodiments. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM’s, CD-ROM’s, diskettes, and tapes) that provides at least a portion of the software instructions for the system. Computer program product 92 can be installed by any suitable software installation procedure, as is well known in the art. In another embodiment, at least a portion of the software instructions may also be downloaded over a cable, communication and/or wireless connection. In other embodiments, the programs are a computer program propagated signal product 75 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like. In other embodiments, the program product 92 may be implemented as a so-called Software as a Service (SaaS), or other installation or communication supporting end-users.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method of creating a verifiable record of asset ownership and asset valuation, the method comprising:
storing data including i) a record of a subject asset comprised of disparate sub-assets and ii) values of the asset and the sub-assets;
automatically determining current values of the sub-assets based on intrinsic characteristics of the sub-assets and market conditions;
updating the stored data based on the determined current values of the disparate sub-assets;
receiving, from a user through an interface, an input comprising a request to purchase a part of the asset at a price;
determining, based on the stored data and the received request, a fraction of the asset equivalent to the price included in the input;
executing a computer readable code stored on a first immutable ledger configured to automatically transfer ownership of the fraction of the subject asset to the user and to record on a secondary immutable ledger, a record of ownership by the user of the fraction of the subject asset; and
providing view access to the second immutable ledger, the view access enabling a third party to verify the record of ownership by the user of the fraction of the subject asset based on the second immutable ledger.

2. The method of claim 1 wherein the sub-assets are real estate assets.

3. The method of claim 1 wherein the computer readable code is a smart contract configured to allow the user to purchase the fraction of the subject asset when executed.

4. The method of claim 1 wherein the first and the second immutable ledgers are blocks in a blockchain.

5. The method of claim 4 wherein the blockchain is an Ethereum blockchain.

6. The method of claim 1 wherein the record of ownership by the user of the fraction of the subject asset comprises a unit of a cryptocurrency.

7. The method of claim 1 wherein automatically determining the current values of the sub-assets employs an algorithm configured to utilize at least one of rental data, tax data, capitalization rates when determining the current values of the disparate sub-assets.

8. The method of claim 7 wherein the algorithm determines current values of the sub-assets in real time.

9. The method of claim 1 wherein the automatically determining of the current values of the sub-assets is performed at a predefined frequency.

10. The method of claim 1 wherein the data including i) a record of a subject asset comprised of disparate sub-assets and ii) values of the asset and the sub-assets is stored on blocks in a blockchain.

11. A computer-based system providing a verifiable record of asset ownership and asset valuation, the system comprising:
a memory configured to store data including i) a record of a subject asset comprised of disparate sub-assets and ii) values of the asset and the sub-assets;
an interface configured to receive, from a user, an input comprising a request to purchase a part of the asset at a price;
a processor configured to:
automatically determine current values of the sub-assets based on intrinsic characteristics of the sub-assets and market conditions;
update the stored data based on the determined current values of the disparate sub-assets; and
determine, based on the stored data and the received request, a fraction of the asset equivalent to the price included in the input; and
a first ledger that stores a computer readable code that, when executed, is configured to automatically transfer ownership of the fraction of the subject asset to the user and to record on a secondary immutable ledger, a record of ownership by the user of the fraction of the subject asset, wherein the second ledger enables a third party to verify the record of ownership by the user of the fraction of the subject asset based on view access to the second immutable ledger.

12. The system of claim 11 wherein the sub-assets are real estate assets.

13. The system of claim 11 wherein the computer readable code is a smart contract configured to allow the user to purchase the fraction of the subject asset when executed.

14. The system of claim 11 wherein the first and the second immutable ledgers are blocks in a blockchain.

15. The system of claim 14 wherein the blockchain is an Ethereum blockchain.

16. The system of claim 11 wherein the record of ownership by the user of the fraction of the subject asset comprises a unit of a cryptocurrency.

17. The system of claim 11 wherein the processor is further configured to utilizes an algorithm configured to utilize at least one of rental data, tax data, capitalization rates when determining the current values of the disparate sub-assets to automatically determine the current values of the sub-assets employs.

18. The system of claim 11 wherein the processor is further configured to utilizes the algorithm to determine current values of the sub-assets in real time.

19. The system of claim 11 wherein the processer is further configured to automatically determining of the current values of the sub-assets is performed at a predefined frequency.

20. The system of claim 11 wherein the memory is located on blocks in a blockchain.
